(19) United States
(12) Patent Application Publication
(10) Pub. No.: US 2018/0335633 A1
(43) Pub. Date: Nov. 22, 2018

(54) VIEWING DIRECTION DETECTOR AND VIEWING DIRECTION DETECTION SYSTEM

(71) Applicant: DENSO CORPORATION, Kariya-city, Aichi-pref. (JP)

(72) Inventor: Youichi NARUSE, Kariya-city (JP)

(73) Assignee: DENSO CORPORATION, Kariya-city, Aichi-pref. (JP)

(21) Appl. No.: 15/777,227

(22) PCT Filed: Oct. 4, 2016
(86) PCT No.: PCT/JP2016/079376

§ 371 Date: May 18, 2018

(30) Foreign Application Priority Data
Nov. 27, 2015 (JP) 2015-231756

(51) Int. Cl. G02B 27/01; G06K 9/00; G06T 7/73; B60R 11/04; B60R 11/00

(52) U.S. Cl. CPC G02B 27/0179; G06K 9/0061; G06K 9/00832; G06T 7/73; G02B 2027/0187; B60R 11/00; G06T 2207/10048; G06T 2207/30201; B60R 2011/0005; B60R 11/04

(57) ABSTRACT

A viewing direction detector includes: an infrared light irradiation unit that uses an infrared light source to irradiate an infrared light; a projection unit that causes the infrared light to be reflected by a windshield or a combiner, and projected in a direction towards an eye of a user; an image acquisition unit that acquires, from an infrared camera for imaging the eye from a direction different to the direction in which the infrared light enters the eye, an infrared camera image having a range including the eye; a recognition unit that recognizes a pupil and a Purkinje image in the infrared camera image acquired by the image acquisition unit; and a viewing direction detection unit that detects the viewing direction of the user from the positional relationship between the pupil and the Purkinje image recognized by the recognition unit.

### CROSS REFERENCE TO RELATED APPLICATION

The present application is based on Japanese Patent Application No. 2015-231756 filed on Nov. 27, 2015, the disclosure of which is incorporated herein by reference.

### TECHNICAL FIELD

The present disclosure relates to a viewing direction detector and a viewing direction detection system.

### BACKGROUND ART

Conventionally, a head-up display apparatus that can detect a viewing position of a driver has been known. The head-up display apparatus described in Patent Literature 1 projects an infrared light to an eye of the driver by using a light path of a display light. The head-up display apparatus photographs a face of the driver by using the light path of a display light. The viewing position of the driver is detected from an infrared camera image obtained by a photographing.

### PRIOR ART LITERATURES

### Patent Literature

Patent Literature 1: JP 2008-155720 A

### SUMMARY OF INVENTION

To detect the viewing direction of the driver may be useful and may be used for various usages such as an adjustment of the head-up display apparatus or the like. In the infrared camera image obtained by the technology described in Patent Literature 1, it may be considered that a pupil and a Purkinje image are recognized and the viewing direction of the driver is detected on the basis of a positional relation between the recognized pupil and the recognized Purkinje image. However, it is difficult to accurately detect the viewing direction based on the infrared camera image obtained by the technology described in Patent Literature 1.

It is an object of the present disclosure to provide a viewing direction detector and a viewing direction detection system that are possible to accurately detect the viewing direction of a user.

According to one aspect of the present disclosure, a viewing direction detector includes: an infrared light irradiation unit that irradiates an infrared light by using an infrared light source; a projection unit that reflects the infrared light at a windshield or a combiner and projects the infrared light towards a direction in which an eye of a user exists; an image acquisition unit that acquires an infrared camera image of a range including the eye from an infrared camera that photographs the eye from a direction in which different from a direction in which the infrared light enters the eye; a recognition unit that recognizes a pupil and a Purkinje image in the infrared camera image, which is acquired by the image acquisition unit; and a viewing direction detection unit that detects a viewing direction of the user on a basis of a positional relation between the pupil and the Purkinje image, which are recognized by the recognition unit.

According to the viewing direction detector, it may be possible to accurately recognize the pupil and the Purkinje image in the infrared camera image. Consequently, it may be possible to accurately detect the viewing direction of the user.

### BRIEF DESCRIPTION OF DRAWINGS

The above and other aspects, features and advantages of the present disclosure will become more apparent from the following detailed description made with reference to the accompanying drawings. In the drawings:

FIG. 1 is an explanatory view illustrating a configuration of a viewing direction detection system;

FIG. 2 is an explanatory view illustrating a position of an infrared camera;

FIG. 3 is a perspective view illustrating a configuration of a HUD apparatus;

FIG. 4 is a plane view illustrating the configuration of the HUD;

FIG. 5 is a block diagram showing an electrical configuration of the viewing direction detection system;

FIG. 6 is a block diagram showing a functional element of a controller;

FIG. 7 is a flow chart showing a process that HUD apparatus operates;

FIG. 8 is an explanatory view showing a positional relation between a pupil and a Purkinje image;

FIG. 9 is a view illustrating the infrared camera image in which the pupil becomes a dark image darker than an iris around the pupil;

FIG. 10 is a view illustrating the infrared camera image in which the pupil becomes a bright image brighter than the iris around the pupil;

FIG. 11 is an explanatory view illustrating the configuration of a viewing direction detection system; and

FIG. 12 is a perspective view illustrating a configuration of the viewing direction detector.

### DESCRIPTION OF EMBODIMENTS

Embodiments of the present disclosure will be explained based on the drawings.

### First Embodiment

### 1. Configuration of a Viewing Direction Detection System 1

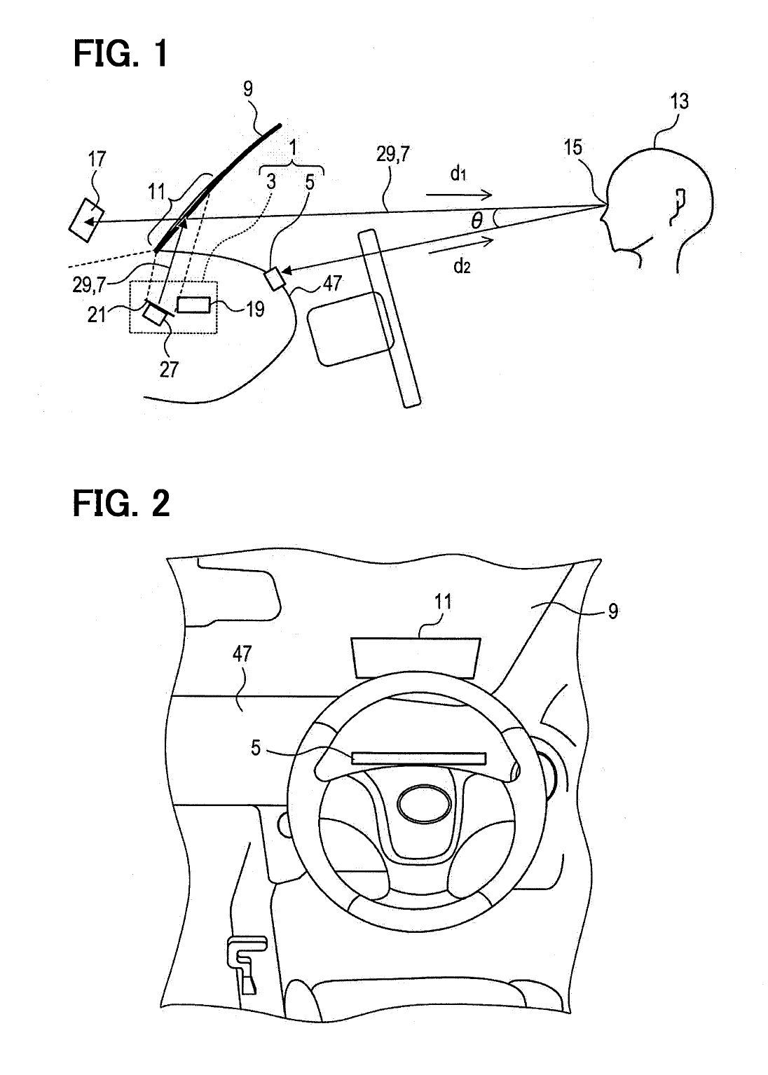

A configuration of a viewing direction detection system 1 will be explained with reference to FIGS. 1 to 6. As shown in FIG. 1, the viewing direction detection system 1 includes a head-up display apparatus 3 and an infrared camera 5. Hereinafter, the head-up display apparatus 3 may be referred to as an HUD apparatus 3. The HUD apparatus 3 corresponds to a viewing direction detector.

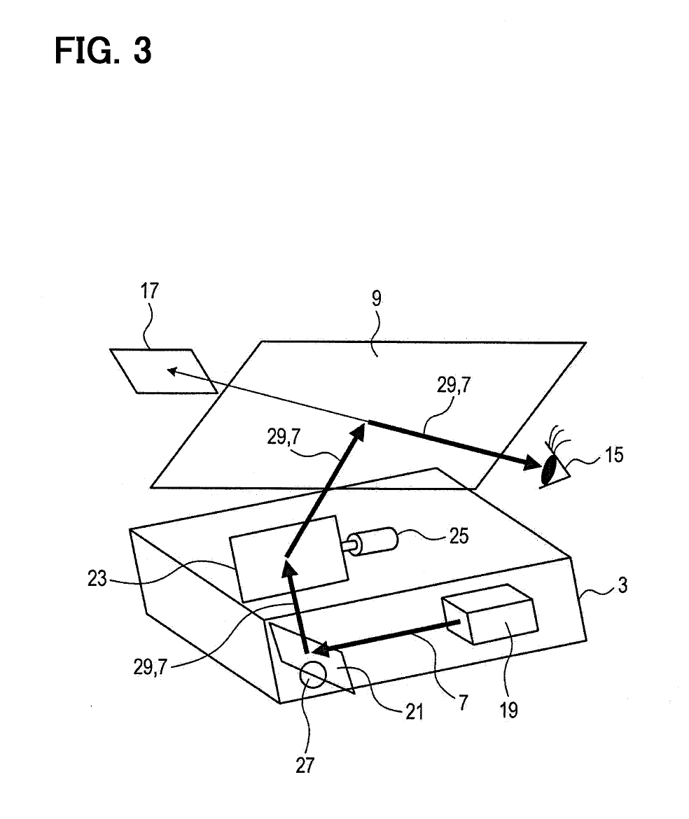

The viewing direction detection system 1 is installed to a vehicle. Hereinafter, a vehicle installed with the viewing direction detection system 1 may be referred to as a subject vehicle. As shown in FIG. 1 and FIG. 3, the HUD apparatus 3 projects a display light 7 displaying a display image to a windshield 9 of the subject vehicle. The display light 7 is visible light. In the windshield 9, an area where the display light 7 enters is set to be as a display area 11. The display light 7 reflected by the windshield 9 enters an eye 15 of a driver 13. The driver 13 can see a virtual image 17 of the display image ahead of the windshield 9. That is, the HUD apparatus 3 projects the display light 7 towards a direction in which the display light 7 is reflected at the windshield 9 and advances to the eye 15.

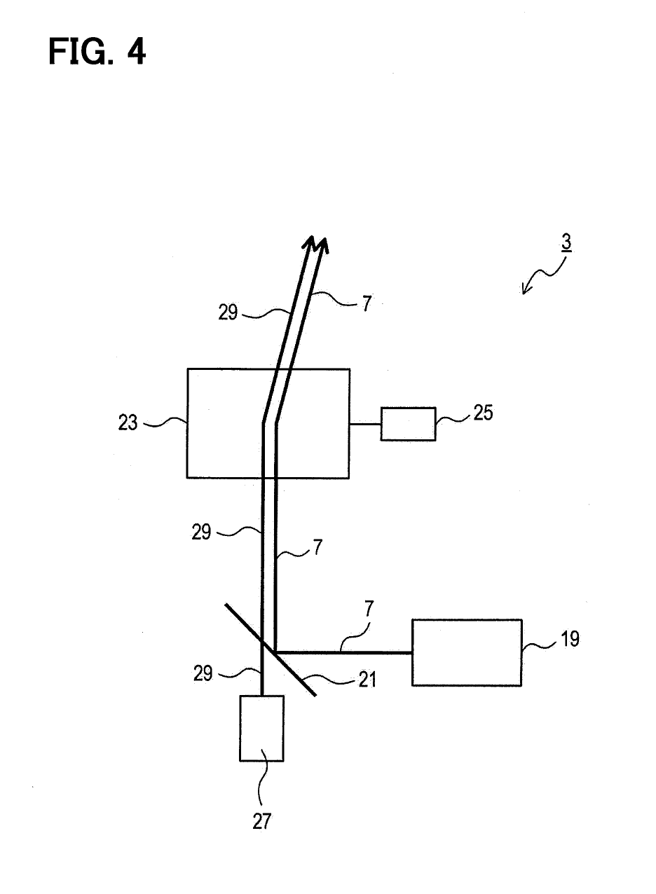

As shown in FIG. 3 and FIG. 4, the HUD apparatus 3 includes a display light irradiation unit 19, a cold mirror 21, a concave mirror 23, an actuator 25 and an infrared light source 27. The cold mirror 21, the concave mirror 23 and the actuator 25 each correspond to a projection unit.

The display light irradiation unit 19 irradiates the display light 7. The cold mirror 21 reflects the display light 7. The cold mirror 21 has a characteristic reflecting the display light 7, which is the visible light, and transmitting an infrared light 29, which will be explained later. The concave mirror 23 further reflects the display light 7 reflected by the cold mirror 21 and projects the display light 7 to the windshield 9. The concave mirror 23 magnifies the display light 7. The actuator 25 changes an angle of the concave mirror 23 in response to a signal sent from a controller 31, which will be explained later. The angle of the concave mirror 23 changes, so that the direction in which the display light 7 and the infrared light 29 are projected changes. Furthermore, a light path of the display light 7 and a light path of the infrared light 29 following to be reflected by the windshield 9 also change.

The infrared light source 27 irradiates the infrared light 29. The irradiated infrared light 29 transmits the cold mirror 21, is reflected by the concave mirror 23, is reflected by the windshield 9, and enters the eye 15. The light path of the infrared light 29 following to transmit the cold mirror 21 is similar to the light path of the display light 7 following to be reflected by the cold mirror 21.

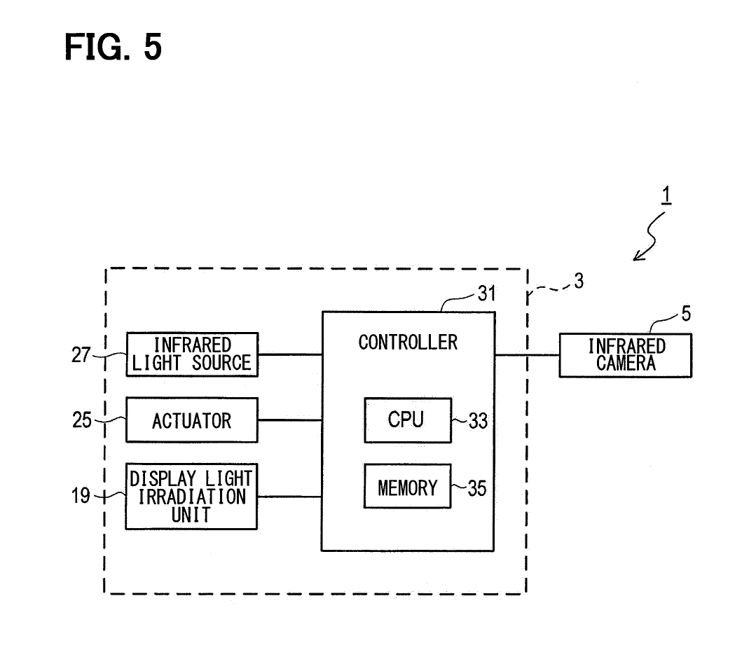

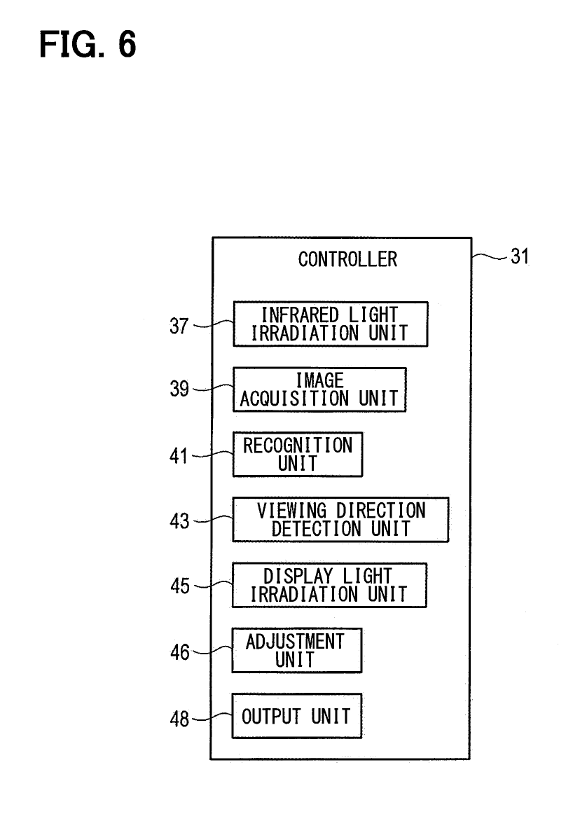

Next, the electrical configuration of the HUD apparatus 3 will be explained based on FIG. 5 and FIG. 6. The HUD apparatus 3 includes the controller 31 in addition to the infrared light source 27, the actuator 25 and the display light irradiation unit 19.

The controller 31 is mainly configured by a well-known microcomputer including a CPU 33 and a semiconductor memory such as a RAM, a ROM and a flash memory (hereinafter, may be referred to as a memory 35). The CPU 33 operates a program stored in a non-transitory tangible storage medium, so that a variety of the function of the controller 31 is implemented. In the example, the memory 35 corresponds to a non-transitory tangible storage medium storing a program. An execution of the program causes to perform a method corresponding to the program. The number of the microcomputer configuring the controller 31 may be one or more.

As shown in FIG. 6, the controller 31 includes, as a functional element implemented by the CPU 33 executing the program, an infrared light irradiation unit 37, an image acquisition unit 39, a recognition unit 41, a viewing direction detection unit 43, a display light irradiation unit 45, an adjustment unit 46 and an output unit 48. The method that implements these elements configuring the controller 31 is not limited to software. All or part element may be implemented by using hardware provided by combining a logic circuit or an analog circuit or the like.

The controller 31 is connected with the infrared camera 5 and controls the infrared camera 5. The controller 31 can acquire an infrared camera image explained later from the infrared camera 5.

As shown in FIG. 1 and FIG. 2, the infrared camera 5 is mounted on a dashboard 47. The infrared camera 5 generates an image at a wave length in an infrared region. A range of the image generated by the infrared camera 5 (hereinafter, may be referred to as an infrared camera image) includes the eye 15. As shown in FIG. 1, a direction d₁ in which the infrared light 29 enters the eye 15 is different from a direction d₂ in which the infrared camera 5 photographs the eye. An angle between the direction d₁ and the direction d₂ is defined as a θ. An absolute value of θ is greater than 0°. In the infrared camera image, which will be explained later, the θ is in the range in which the pupil is set to become a dark image darker than the iris around the pupil. As the absolute value of the θ increases, it is likely that the pupil becomes the dark image compared with the iris around the pupil in the infrared camera image. The infrared camera 5 outputs the generated infrared camera image to the controller 31.

### 2. Viewing Direction Detection Process Performed by the Viewing Direction Detection System 1

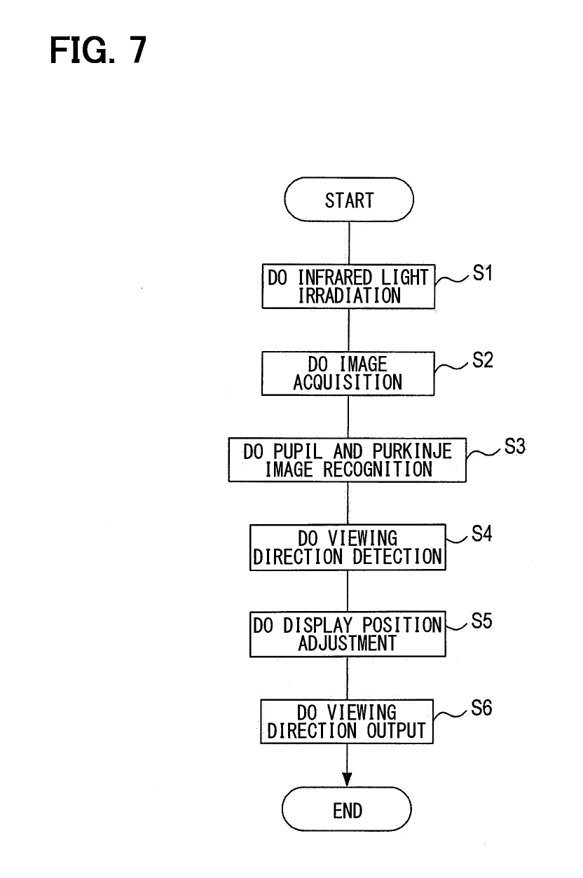

The viewing direction detection process performed by a viewing direction detection system 1 will be explained based on FIGS. 7 to 9. The viewing direction detection process may be performed at a timing instructed by the driver 13, or may be performed at the timing with set in advance, or may be repeatedly performed for every predetermined time.

In Step 1 of FIG. 7, the infrared light irradiation unit 37 irradiates the infrared light 29 by using the infrared light source 27. As described above, the infrared light 29 transmits the cold mirror 21, is reflected by the concave mirror 23, additionally is reflected by the windshield 9 and enters the eye 15.

In Step 2, the image acquisition unit 39 acquires the infrared camera image by using the infrared camera 5.

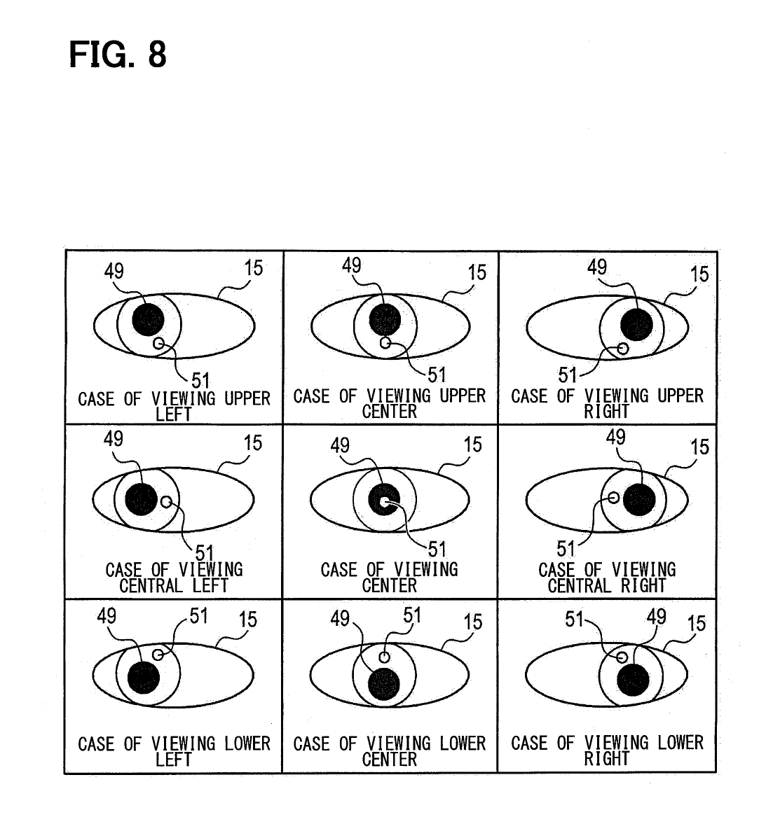

In Step 3, the recognition unit 41 recognizes a pupil 49 and a Purkinje image 51 from the infrared camera image acquired in Step 2 by a well-known image recognition technology, as shown in FIG. 8. The Purkinje image 51 is a reflected image on a corneal surface.

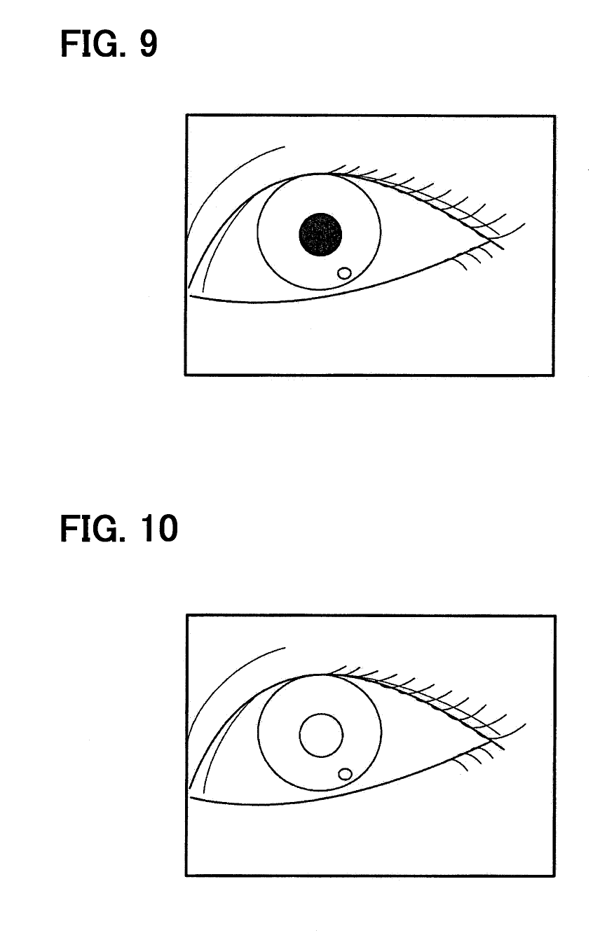

As shown in FIG. 9, the pupil 49 becomes the dark image darker than the iris around the pupil in the infrared camera image acquired in Step 2. When the θ is 0°, the pupil in the infrared camera image becomes a bright image brighter than the iris around the pupil, as shown in FIG. 10.

In Step 4, the viewing direction detection unit 43 detects the viewing direction of the driver 13 on the basis of the positional relation of the pupil 49 and the Purkinje image 51, which are recognized in Step 3.

As shown in FIG. 8, the viewing direction of the driver 13 and the positional relation between the pupil 49 and the Purkinje image 51 have a correlation. The viewing direction detection unit 43 stores in advance a map regulating the correlation between the positional relation of the pupil 49 and the Purkinje image 51, and the viewing direction of the driver 13. The viewing direction detection unit 43 inputs the positional relation between the pupil 49 and the Purkinje image 51 recognized in Step 3, so as to detect the viewing direction of the driver 13.

In Step 5, the adjustment unit 46 adjusts a direction of the concave mirror 23 with the actuator 25. The adjustment adjusts the light path of the display light 7 corresponding to the viewing direction of the driver 13 detected in Step 4.

In Step 6, the output unit 48 outputs the viewing direction of the driver 13 detected in Step 4 to a different on-board apparatus.

The different on-board apparatus includes, for example, an apparatus that determines whether the driver 13 visually recognizes a surrounding object based on the viewing direction of the driver 13, and outputs an alarm or performs a process to the subject vehicle when the apparatus determines that the driver 13 does not visually recognize the object. As the object, for example, a traffic signal, a traffic sign, another vehicle, a pedestrian, or the like may be considered. As the process to the subject vehicle, for example, an alarm process, an automatic brake and an automatic steering or the like may be considered.

### 3. Display Process Performed by the HUD Apparatus 3

The HUD apparatus 3 performs a display process basically similar to a well-known HUD apparatus. The display light irradiation unit 19 irradiates the display light 7. The display light 7 is reflected by the cold mirror 21, the concave mirror 23 and the windshield 9 and enters the eye 15 sequentially. The driver 13 sees the virtual image 17 of the display image ahead of the windshield 9. The angle of the concave mirror 23 is the angle adjusted by the process of Step 5.

### 4. Effect of the Viewing Direction Detection System 1

(1A) The viewing direction detection system 1 acquires the infrared camera image in the range including the eye 15 from the infrared camera 5. The infrared camera 5 photographs the eye 15 from the direction d₂ that is different from the direction d₁ in which the infrared light 29 enters the eye 15. Therefore, in the infrared camera image, it may be possible to more accurately recognize the pupil 49 and the Purkinje image 51. Consequently, it may be possible to more accurately detect the viewing direction of the driver 13.

(1B) The HUD apparatus 3 projects the display light 7 and the infrared light 29 by using the cold mirror 21, the concave mirror 23 and the actuator 25. Therefore, optical systems to project the infrared light 29 is unnecessary to be separately provided. Consequently, it may be possible to make the viewing direction detection system 1 compact.

(1C) The HUD apparatus 3 includes the cold mirror 21 reflecting the display light 7 and transmitting the infrared light 29. The display light 7 reflected by the cold mirror 21 and the infrared light 29 transmitting the cold mirror 21 advance along the same light path. Thereby, it may be possible to more simplify the configuration of the HUD apparatus 3.

(1D) In the viewing direction detection system 1, the value of the θ is in the range in which the pupil 49 becomes the dark image darker than the iris around the pupil 49 in the infrared light camera image. Thereby, in the infrared camera image, it may be possible to more accurately recognize the pupil 49 and the Purkinje image 51. Consequently, it may be possible to more accurately detect the viewing direction of the driver 13.

(1E) The infrared camera 5 is installed to the dashboard 47. Therefore, it may be possible to set the value of the θ sufficiently large.

### Second Embodiment

### 1. Difference from the First Embodiment

Since a basic configuration of a second embodiment is similar to the first embodiment, the explanation with respect to the common configuration will be omitted and a difference will be mainly explained. An identical reference with the first embodiment shows a same configuration and refers to a preceding explanation.

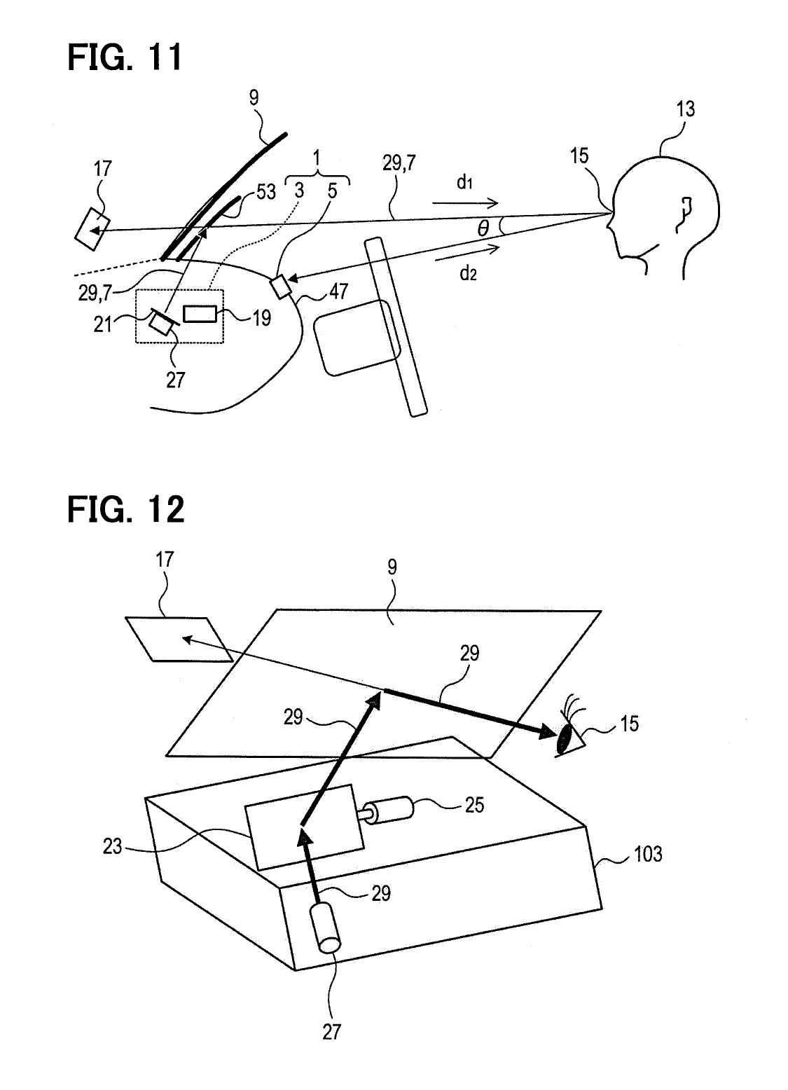

According to the first embodiment above described, the windshield 9 reflects the display light 7 and the infrared light 29. By contrast, according to the second embodiment, as shown in FIG. 11, a point that a combiner 53 reflects the display light 7 and the infrared light 29 is different from the first embodiment. After reflected by the combiner 53, the display light 7 and the infrared light 29 enter the eye 15.

### 2. Effect Provided by the Viewing Direction Detection System 1

According to the second embodiment described above, it may be possible to obtain the similar effect with the effect of the first embodiment.

### Third Embodiment

### 1. Difference from the First Embodiment

Since a basic configuration of a third embodiment is similar to the first embodiment, the explanation with respect to the common configuration will be omitted and a difference will be mainly explained. An identical reference with the first embodiment shows a same configuration and refers to a preceding explanation.

According to the first embodiment previously described, the HUD apparatus 3 is used. By contrast, according to the third embodiment, a viewing direction detector 103 is used. The viewing direction detector 103 does not project the display light 7. As shown in FIG. 12, the viewing direction detector 103 includes the concave mirror 23, the actuator 25 and the infrared light source 27. The concave mirror 23 and the actuator 25 each corresponds to a projecting unit. The light path of the infrared light 29 is similar to the first embodiment.

### 2. Effect Provided by the Viewing Direction Detection System 1

According to the third embodiment described above, it may be possible to obtain the similar effect with the effect of the first embodiment (1A), (1D).

### Other Embodiments

The embodiment described above is an example. It may be possible to provide other various embodiments.

(1) It may be possible to appropriately select a position of the infrared camera 5. For example, the infrared camera 5 may be mounted on a rearview mirror or the like.

(2) The viewing direction detection system 1 may detect a viewing direction of an occupant of the subject vehicle other than the driver 13.

(3) According to the embodiment, multiple functions that one functional element has may be implemented by multiple functional elements. One function that one functional element has may be implemented by multiple functional elements. Multiple functions that multiple functional elements have may be implemented by one functional element. One function implemented by multiple functional elements may be implemented by one functional element. A part of the configuration of the embodiment may be omitted. At least part of the configuration of the embodiment may be omitted. At least part of the configuration of the embodiment may be added and replaced to the configuration of the other embodiment.

(4) Except for the HUD apparatus, various embodiments may be possible to include the system setting the HUD apparatus as a configuration element, the program to function the computer as the controller of the HUD apparatus, the non-transitory tangible storage medium such as the semiconductor memory having recorded the program, a viewing direction detection method and an adjustment method of the HUD apparatus or the like.

What is claimed is:

1. A viewing direction detector comprising:
an infrared light irradiation unit that irradiates an infrared light by using an infrared light source;
a projection unit that reflects the infrared light at a windshield or a combiner and projects the infrared light towards an eye of a user;
an image acquisition unit that acquires an infrared camera image of a range including the eye from an infrared camera that photographs the eye from a direction different from a direction in which the infrared light enters the eye;
a recognition unit that recognizes a pupil and a Purkinje image in the infrared camera image, which is acquired by the image acquisition unit; and
a viewing direction detection unit that detects a viewing direction of the user on a basis of a positional relation between the pupil and the Purkinje image, which are recognized by the recognition unit.

2. The viewing direction detector according to claim 1, further comprising:
a display light irradiation unit that irradiates a display light displaying a display image,
wherein:
the projection unit is configured to display a virtual image of the display image to the user by reflecting at the windshield or the combiner the display light irradiated by the display light irradiation unit and by projecting the display light towards the eye of the user.

3. The viewing direction detector according to claim 2, wherein:
the projection unit includes a cold mirror reflecting the display light and also transmitting the infrared light; and
the display light reflected by the cold mirror and the infrared light transmitting the cold mirror advance along a same light path.

4. A viewing direction detection system comprising:
the viewing direction detector; and
the infrared camera, according to claim 1.

5. The viewing direction detection system according to claim 4, wherein:
an angle between the direction in which the infrared light enters the eye and a direction in which the infrared camera photographs the eye is in a range in which the pupil becomes a dark image darker than an iris around the pupil in the infrared camera image.

6. The viewing direction detection system according to claim 4, wherein:
the infrared camera is installed to a dashboard.
